(19) United States
(12) Patent Application Publication
(10) Pub. No.: US 2003/0131254 A1
(43) Pub. Date: Jul. 10, 2003

(54) Method for preventing the falsification of access cards

(76) Inventors: Norbert Miller, Monchengladbach (DE); Elmar Noll, Monchengladbach (DE)

Correspondence Address: CANTOR COLBURN, LLP, 55 GRIFFIN ROAD SOUTH, BLOOMFIELD, CT, 06002

(21) Appl. No.: 10/037,662

(22) Filed: Jan. 4, 2002

(51) Int. Cl. G06F 11/30

(52) U.S. Cl. 713/200

(57) ABSTRACT

In order to make available a method for preventing the falsification of access cards as well as an identification card which provides the greatest possible control opportunity and comprehensive protection from forgery at low cost and with little technical effort, a method for preventing the falsification of access cards (which contain plain text information that identifies the type of authorization) is proposed, wherein the plain text information is encoded by using a key, and the resulting code is applied to the access card.

The present invention relates to a method for preventing the falsification of access cards, on which plain text information identifying the type of authorization is applied. Furthermore the invention relates to an access card for use in a forgery-proof system.

Access cards are used and common in many areas, e.g. transportation ticket access cards, airline tickets, but also admission tickets, parking identification cards and similar. The problem is explained in the following based upon transportation ticket access card technology.

In the transportation ticket access card technology, a customer is issued an identification card as proof of authorization to obtain a transportation service. These ticket I.D. cards generally contain imprints in plain text, such as about

the geographic validity of the ticket I.D. card, start and end of a trip, fare zones, areas of validity and the like;

the time validity of the ticket I.D. card;

the vehicle/seating category;

the class of people for whom the ticket I.D. card is valid, wherein typical price reductions generally require an examination by control personnel in order to check the authorization for student rates, retiree rates, social rates, advantage cards such as the rail pass or the like and

other information such as the ticket price, serial number of the ticket, number of sale device etc.

Details of this information are dependent upon the fare concept of the respective transportation authority and/or the transportation association.

The information mentioned in the examples can also be stored on a ticket I.D. card in a machine-readable format. The purpose for this is on one hand the machine-controlled granting of access to a traffic system, wherein the system in this case is closed and can be accessed and/or left through machine-controlled barriers. On the other hand, the purpose is a machine-controlled access to a traffic system, wherein the ticket I.D. cards are read by machines under human supervision, e.g. when accessing buses etc., which are equipped with a reading device on the entrance side, as is the case e.g. in the United States. The driver in this case monitors the machine-based reading process. Another purpose is the machine-supported control of ticket I.D. cards in traffic systems. In this case, the checking person in the vehicle uses a portable reading device, which reads the machine-readable data, evaluates it and informs the checking person about the result.

Common methods for applying machine-readable information onto ticket I.D. cards are magnetic strips or electronic storage media such as chip cards, transponder cards and the like.

Apart from the fact that these methods have the disadvantage of being connected with relatively expensive technology, be it devices for handling magnetic strips or the application of electronic storage media onto the ticket, both chip cards and transponder cards can be manipulated, i.e. against electronic verification, be destroyed, or the like.

Against the background of the described state of the art, underlying the present invention is the task of providing a method for preventing the falsification of access cards as well as access cards, which make the greatest possible control possibility and a comprehensive protection from forgery available with little economical and technological expenditure.

For the technical solution of this task, in terms of the process, a method is suggested for preventing the falsification of access cards that contain plain text information, which identifies the type of authorization, wherein the plain text information is encoded by applying a key and the resulting code is introduced onto the access card.

The invention beneficially suggests encoding plain text information by utilizing a key and likewise applying the code on the I.D. card. Pursuant to an advantageous suggestion of the invention, this occurs with an imprint. Advantageously, the applied code is machine-readable, e.g. a bar code.

An access card, which can at least be imprinted, is usually paper-based and requires neither magnetic strips nor electronic storage media, is equipped during its production with an imprint in plain text and a machine-readable imprint. This can, for example, be a bar code. The information depicted in the bar code is additionally protected by encoding the represented data. The encoding increases the falsification safety because it represents an impossible barrier even for such forgers, who are able to duplicate ticket I.D. cards with changed or modified plain text, because without knowledge of the key, no duplicable connection can be established between the plain text and the bar code.

Advantageously, the code can be converted back or reproduced. For example, within the framework of the invention, it is suggested that the coding be detected with a computer, a reading device, a hand-held computer or the like. This can occur by typing on a keyboard or automatic machine-based reading. Initially the bar code can be equipped with acceptance information, which already makes duplication more difficult. It is suggested that different information be encoded with different keys, preferably in such a way that each different key is selected as a function of features of the respective access card. Furthermore the bar code is decoded by applying the preferably secret key, and the plain text information is thus prepared. This can occur, for example, by using a database. Conversely, the plain text information is detected in the computer and can be encoded again by using the secret key. Consequently, various checks can be conducted. Hence, upon reproduction of the code from plain text information, the reproduced code can be compared to the code on the access card. When the code that has been applied to the access card is detected, the plain text information can be formed and be compared to the plain text information on the access card. This way, inconsistencies can be detected without difficulty.

Beneficially a variety of keys can be used in order to make forgery even more difficult. Here check digits can be used, which refer to a certain key from a large number of stored keys. This way the key selection is a dynamic process and can be connected to the information that is supposed to be depicted.

The invention makes a new access card available, which apart from plain text information contains a code that is determined by applying a key, which can be imprinted and/or imaged in machine-readable format. Such an access card enables setting up a forgery-proof and simple control system.

The invention in particular enables the production of access cards in low-price segments, for example for short validity periods, low ticket cost and the like, in a cost effective way. This is supported by low material costs and low equipment costs for handling. This way an economical balance between the encoding expenses and the falsification safety is achieved. Further benefits of the invention result from the possibility of utilizing materials disposable in an environmentally friendly manner, wherein disposal is possible without separation, the use of so-called image scanners in relocated image-relocating software and the like, thus a simple adjustment to current technology.

Further advantages and features result from the following description based on the figures. They show:

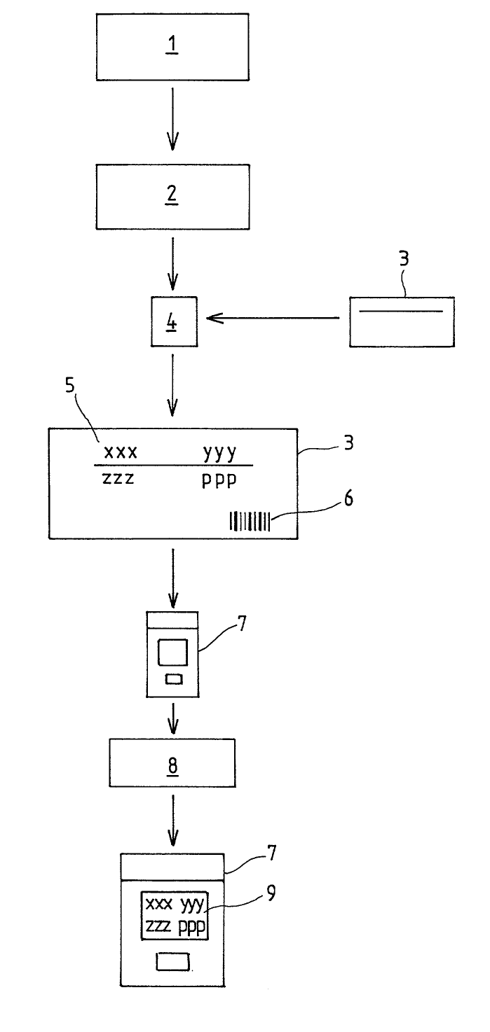

FIG. 1 a diagrammatic representation of a system for utilizing the invented access cards with the method of the invention.

In method step 1, e.g. by using a machine; a user makes a product selection, for example a trip from, to, at a certain time, at a certain price. In method step 2, on the part of the machine, plain text information is compiled on the basis of this information through a computer, which is converted into a code using a secret key. By feeding a, for example, paper ticket 3, in method step 4 the ticket is imprinted so that the ticket 3 is provided with plain text information 5 and a code, in the example shown a bar code 6. In order to be able to perform controls, a reading device 7 reads the code 6 in the shown example. In method step 8, the code 6 is converted by applying a key, and the plain text information is determined. On the reading device 7, designed as a portable unit, a monitor indicates the plain text information 9 to the control personnel. Consequently, it is directly possible to compare the plain text information 5 that is applied onto the access card 3 with the plain text information 9 that is determined from the code 6 and thus to check the validity of the access card.

The described embodiment only serves the explanation of and does not limit the invention.

Reference List:

| | |
|---|---|
| 1 | Product Selection |
| 2 | Coding |
| 3 | Ticket |
| 4 | Imprint |
| 5 | Plain text |
| 6 | Bar Code |
| 7 | Reading Device |
| 8 | Decoding |
| 9 | Plain text Display |

1. Method for preventing the falsification of access cards containing plain text information that identifies the type of authorization, whereby the plain text information is encoded by applying a key and the resulting code is introduced onto the access card.

2. Method pursuant to claim 1, characterized in that the code is applied with an imprinting process.

3. Method pursuant to one of the previous claims, characterized in that the code is made machine-readable.

4. Method pursuant to one of the previous claims, characterized in that the code can be converted back into plain text information by using the key.

5. Method pursuant to one of the previous claims, characterized in that the code can be reproduced.

6. Method pursuant to one of the previous claims, characterized in that, with the help of a computer the agreement of the plain text information with the code can be checked a key stored in the computer.

7. Method pursuant to claim 6, characterized in that the respectively different keys are selected as a function of features of the respective access card.

8. Method according to claim 6 or claim 7, characterized in that a secret key is used.

9. Identification card with plain text information identifying the type of authorization, characterized in that it contains a code that can be determined from the plain text information by using a key.

10. Identification card pursuant to claim 9, characterized in that it contains an imprinted code.

11. Identification card pursuant to one of the claims 9 or 10, characterized in that it contains a machine-readable code.
